(19) United States
(12) Patent Application Publication
(10) Pub. No.: US 2014/0083243 A1
(43) Pub. Date: Mar. 27, 2014

(54) Method and Means for Anchoring Casing Mounted Transmission

(71) Applicant: Wm. Bruce Morrow, Santa Barbara, CA (US)

(72) Inventor: Wm. Bruce Morrow, Santa Barbara, CA (US)

(21) Appl. No.: 13/625,017

(22) Filed: Sep. 24, 2012

(51) Int. Cl. F16H 57/021

(52) U.S. Cl. 74/606 R

(57) ABSTRACT

In a down hole transmission having a gear set and supporting elements for aligning and securing the gear set. Tie elements disposed between the supporting elements and the housing to secure the gear set against torsional forces on a gear set.

The present invention relates generally to transmissions used in down hole fluid recovery systems mounted within well casing and, more particularly, to the apparatus and method for anchoring such transmission gear sets within the transmission housing.

### BACKGROUND OF THE INVENTION

1. Field of the Invention

The present invention was developed and created primarily for use with transmissions employed in down hole fluid recovery systems. More particularly, it was created to anchor a transmission used in the downhole fluid recovery industry, primarily oil and, in rare situations, water.

Most oil deposits at some time during their producing life will require some type of artificial lift system to bring the produced oil and water to the surface. One such artificial lift method is the Geared Centrifugal Pump, as described in Morrow patent 5,960,886, where a downhole centrifugal pump is driven by a rotating rod string powered at the surface, via a downhole speed step up, or increasing transmission.

The transmission is needed to increase the rotational speed of the rotating drive string from a typical 500 RPM to the 3500 RPM required by the multi-stage centrifugal pump.

Those skilled in the art will appreciate that just any old transmission is not going to work. A transmission for use in the environment as herein described must fit within the casing which brings the fluid being pumped from its source well below ground to the surface. Accordingly, the transmission housing must have an outside diameter smaller than the inside diameter of the subject casing. Moreover, it must have gearing which is sufficiently stout so as to handle the torsional loads being experienced by it as the surface power source supplies motive power to the submerged pump, and those loads are significant.

A well casing mounted transmission, i.e., one mounted wholly within the casing, like virtually all transmissions, must have a reaction member against which torsional loads are placed on the transmission gearing by the power input. Absent such reaction member, the entire gear set of the transmission would simply rotate with the power input shaft, and there would be no step up or step down of the torque or speed of rotation.

The focus of the present invention is on the creation of a suitable reaction member capable of efficiently permitting the transmission to function as designed.

2. Identification of Related Art

Clearly the most relevant art relating to the present invention is found in the current practice among those building downhole transmissions for the industry. The most obvious reaction member is the transmission housing itself and, in order to create the necessary reaction to stabilize the gear set and render it operable, is to permit the gear set to operate against the transmission housing. That operation is accomplished, currently, by the use of multiple steel pins inserted through the housing wall and into components of the transmission to secure the gear set within the transmission to the torsionally stiff transmission housing, thereby precluding, or at least greatly reducing, the twisting or other deformation of the transmissions operating elements within the housing.

The current state-of-the-art method calls for a series of 60 to 75 holes being drilled through the wall of the housing along its length at strategic positions and into companion holes formed in the components of the transmission within the housing and, thereafter, inserting steel pins in the aligned holes. Weld material is then used to seal the holes and complete the connection between nonrotating internal transmission components and the transmission housing.

The system currently in use as described above has several drawbacks which make it less than desirable. A large number of holes, albeit smaller in diameter, tend to compromise the strength of the housing and create an enormous number of potential points of failure when the transmission is under significant pressure during use. It also compromises the burst strength of the housing, further weakening the entire system. It will also be recognized by those skilled in the art that the process of drilling, pinning and welding is both time-consuming and expensive.

### SUMMARY OF THE INVENTION

The present invention is intended to address and remedy the shortcomings and deficiencies of the existing method of providing a reaction member against which the transmission is able to achieve its purpose.

It is the additional purpose and objective of the present invention to permit the transmission of the present invention to achieve its purpose with optimum efficiency.

Another object of the present invention is to secure the gear set against rotation as a unit with the drive shaft in order that the gear set can create a substantial increase, or step up, in rotational speed to the downhole pump driven by it.

It is yet another, and still further, objective and benefit of the present invention to accomplish the goals set forth herein for it without impairing the ability of the transmission housing to withstand the fluid pressures to which it will be subjected during operation.

Additional and still further objectives and advantages will occur to those skilled in the art when considering preferred embodiments of the present invention, read in conjunction with the accompanying drawings, wherein:

### BRIEF DESCRIPTION OF THE DRAWINGS

FIG. 1 is a cross-sectional view of a downhole transmission which utilizes a novel pinning system of engaging non rotating components of the transmission with the external housing;

FIG. 2 shows the same cross-sectional view of a downhole transmission which employs an alternative method of engaging the transmission components with the external housing;

FIG. 3 is an enlarged partial sectional view taken along arc 2-2 of FIG. 2;

FIG. 4 is a partial sectional view of FIG. 2 taken along arc 2-2, and illustrating an alternative structure for creating an engagement between a transmission component and the transmission housing of FIG. 2;

FIG. 5 is a partial sectional view of FIG. 2 taken along arc 2-2 and illustrating yet another alternative structure for creating engagement between a transmission component and the transmission housing of FIG. 2;

FIG. 6 is a partial sectional view of FIG. 2 taken along arc 2-2 and illustrating a still further alterative structure for creating engagement between a transmission component and the transmission housing of FIG. 2; and,

FIG. 7 is a partial sectional view of FIG. 2 taken along arc 2-2 and illustrating an additional and further structure for creating engagement between a transmission component and the transmission housing of FIG. 2.

### DETAILED DESCRIPTION OF THE SEVERAL ALTERNATIVE EMBODIMENTS

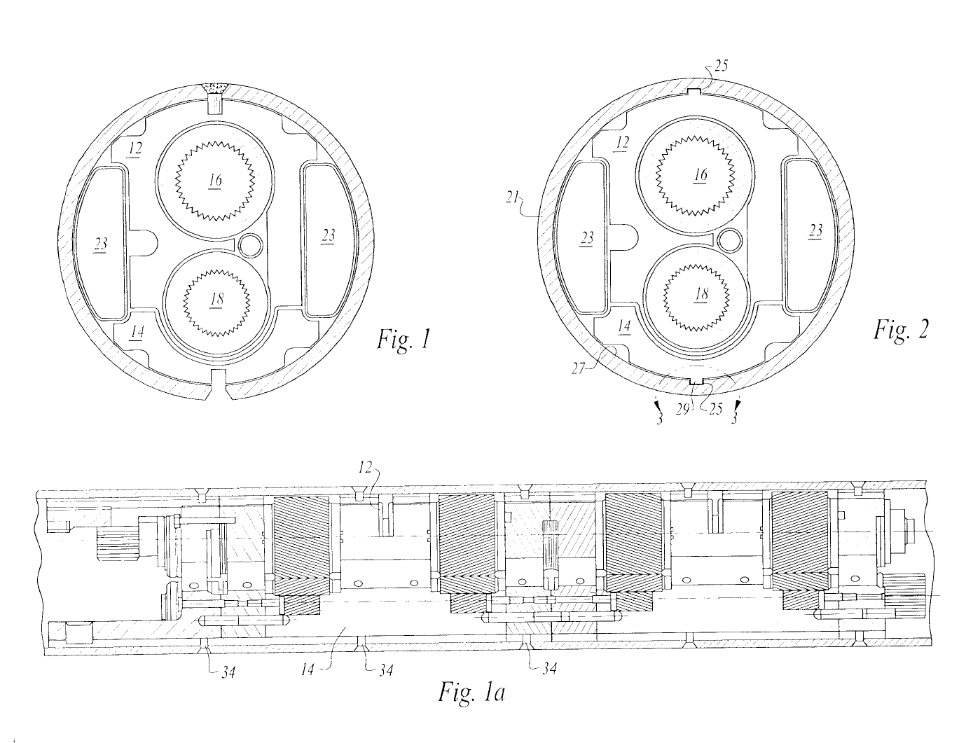

Referring now to the drawings, and initially to FIG. 1, the environment in which the present invention has particular utility, is there shown.

A transmission T is illustrated in cross section. The transmission illustrated is of the type which is the subject of application Ser. No. 13/008,205 filed Jan. 18, 2011 on behalf of the present inventor William Bruce Morrow.

The transmission T encloses a gear set having non rotating support elements, as illustrated, are in the nature of bearing blocks 12 and cradles 14 supporting input shafts 16 and driven shafts 18 of the gear sets. These input, or drive shafts and driven shafts engage the gears via a male spline on the surface of the respective shafts which mates with a female spline formed on an internal bore passing axially through each gear [not shown], as illustrated in FIG. 1. A transmission housing 21 encases the gear set and associated support elements, and D tubes 23 flank the gear set, providing passage for fluid being delivered to the surface from the downhole pump (also not shown) submersed in the fluid to be raised to the surface by the pump.

The challenge addressed by the present application is to create a superior substantially rigid, bond between the transmission components, in this case either, or both, of the bearing blocks 12 and/or cradles 14 and the transmission housing 21 to thereby create the torsional resistance needed to permit the transmission T to function efficiently in accordance with the objectives attributed to the present invention.

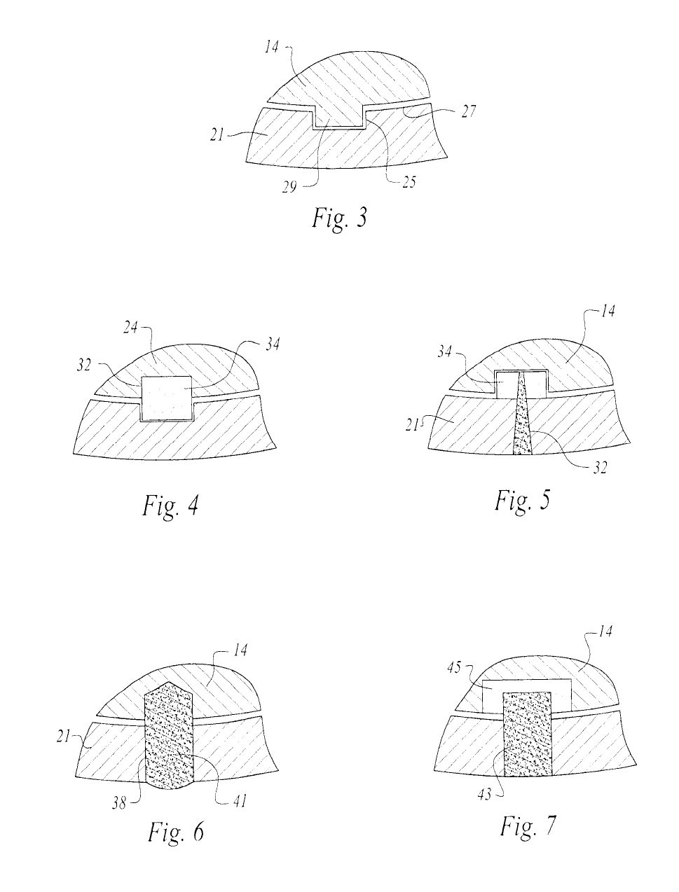

Thus, in keeping with the present invention and with reference to FIGS. 2 and 3, a longitudinally extending opening in the form of a keyway 25 is machined, or otherwise formed, in the surface 27, representing the internal diameter of the transmission housing 21.

Further, in accordance with the invention, a rigid tie element, in this instance an integrally formed, longitudinally extending, projection in the nature of a key 29 is machined, or otherwise formed or provided, on the surface of a bearing block 12 and/or the cradle 14. Each key 29 is so positioned as to precisely align with a longitudinal slot 25. Thus, when the transmission is assembled, the cradle and bearing block are inextricably joined with the transmission housing. Accordingly, the torque experienced by the drive shaft as it is powered by the surface power source (not shown) is unable to rotate, or twist, the gear set mounted to the driving driven shafts 16 and 18 respectively, and the step up speed generated by the transmission is readily transmitted downhole to the pump.

As those who are skilled in the art will attest, it is not an easy process to form a slot 25 or the key 29. A somewhat easier approach to the same structural approach is illustrated in FIG. 4. In that configuration, an opening such as longitudinal slot 32 is formed, in the cradle or the bearing block, and/or both.

A separate tie element such as a key 34 is formed and during assembly of the transmission, is inserted into the slots, or keyways, formed in the surface 27 and the cradle and bearing block respectively, thereby inhibiting any torsional movement between the transmission housing and the internal gear set and related stabilizing structure during operation.

Moving now to FIG. 5, a slightly modified version of FIG. 4 is there illustrated. In the FIG. 5 embodiment, a tie element, e.g., a key 34, is fitted in the keyway. The transmission components are inserted into the housing and at intervals along the length of the housing, a laser welding tool is used to penetrate the housing, creating small holes. The spacing of these laser welds along the housing is dictated by the expected torque of the transmission. The welder further penetrates the key 34. The laser then deposits weld material which fills the hole cut by the laser in both the housing 21 and the key 34, thereby holding the transmission components rotationally fixed relative to the housing. Alternatively, it is possible to laser weld directly through the housing wall and into a non rotational transmission component. However, this alternative method would not allow expansion of the housing due to increased internal pressure during pumping operations and may result in welds breaking as the housing expanded away from the transmission.

Tying the laser weld to the key, on the other hand, allows the housing to expand without putting the welds in great tension, while still keeping the transmission fixed rotationally relative to the housing.

The FIG. 6 embodiment most resembles, but is patentably distinct from the current mode of connection. It differs in that an opening in the form of a hole 38 is through the housing and into the cradle 14 and that entire hole is filled with weld material 41, the weld material taking the place of the steel pin of the current mode of connection.

Finally, in the FIG. 7 embodiment, the holes are drilled in the housing, and pass through the housing wall 21 and into a key 45 fitted into keyways machined into the cradle 14. Each hole formed through the housing and into the key are then filled with weld material, torsionally linking the housing rigidly to the transmission gear set.

As in the FIG. 5 embodiment, the weld extends into the key, rather directly into the transmission component, to allow radial expansion of the housing due to internal pressure.

In summary, the present invention provides tie elements by various interrelated methods for creating the necessary connection between the transmission housing and the gear set and supporting structure within in it to permit the transmission to provide the of a step up speed necessary to drive the downhole pump.

As the present invention has been described in considerable detail and illustrated with respect to several variations on a preferred embodiment, it will be apparent to those skilled in the art that various modifications and permutations of the recited structure are possible. It will be appreciated that such modifications are within the contemplation of the claims following.

1. In a downhole transmission said transmission including a housing, a gear set in said housing and at least one nonrotating support elements, said transmission component supporting said gear set;
a plurality of openings formed in said housing; a plurality of openings formed in said nonrotating support elements, said openings in said housing and said openings in said nonrotating support elements being aligned to define a single passage;
tie elements, each said tie elements being disposed in an opening in said housing aligned with an opening in said nonrotating support elements to thereby rigidly tie said support elements to said housing.

2. The downhole transmission of claim 1, wherein at least one bearing block is provided in said housing, said bearing block comprising a nonrotating support element.

3. The downhole transmission of claim 1, wherein at least one cradle is provided in said housing, said cradle comprising a nonrotating support element.

4. The downhole transmission of claim 1, wherein at least one bearing block and at least one cradle is provided in said housing, said bearing block and cradle each comprising a nonrotating support element.

5. The downhole transmission of claim 4, wherein a plurality of bearing blocks and cradles are provided in said housing, said bearing blocks and cradles each comprising a nonrotating support element.

6. In a downhole transmission said transmission including a housing, a gear set in said housing and at least one nonrotating support element, said nonrotating support element supporting said gear set;
at least one longitudinally extending opening formed in said housing, a longitudinally extending slot formed in said nonrotating support element, said longitudinally extending element fitting in said slot to thereby restrict movement of said nonrotating support element relative to said housing;
said longitudinally extending element inserted in said slot in said housing to thereby rigidly restrict movement of said nonrotating support element relative to said housing.

7. (canceled)

8. The downhole transmission of claim 6, wherein said tie element comprises a key.

9. The downhole transmission of claim 6, wherein a hole is formed in said housing, said hole extending through said longitudinally extending element and into said nonrotating support elements, said hole being filled with weld material.

10. The downhole transmission of claim 8, wherein an opening is formed through said housing and into said key;
said opening being filled with weld material.

11. The down hole transmission of claim 6, wherein said longitudinally extending element is integrally formed with said housing.
